(19) United States
(12) Patent Application Publication
(10) Pub. No.: US 2013/0207967 A1
(43) Pub. Date: Aug. 15, 2013

(54) IMAGE PROCESSING APPARATUS AND METHOD

(71) Applicants: Samsung Electronics Co., Ltd., (US); Industry-Academic Cooperation Foundation, Yons, (US)

(72) Inventors: Jeong Soo PARK, Gwacheon-si (KR); Won Jong Lee, Seoul (KR); Seok Yoon Jung, Seoul (KR); Jin Woo Kim, Seoul (KR); Jae Ho Nah, Seoul (KR); Jun Ho Park, Seoul (KR); Tack Don Han, Seoul (KR)

(73) Assignees: Industry-Academic Cooperation Foundation, Yonsei University, Seoul (KR); Samsung Electronics Co., Ltd., Suwon-si (KR)

(21) Appl. No.: 13/677,694

(22) Filed: Nov. 15, 2012

(30) Foreign Application Priority Data
Feb. 10, 2012 (KR) 10-2012-0013518

(51) Int. Cl. G06T 15/06

(52) U.S. Cl. CPC G06T 15/06
USPC 345/419

(57) ABSTRACT

Provided is an image processing apparatus. The image processing apparatus may determine whether a ray and a bounding volume including a primitive intersect each other, prior to determining whether the primitive and the ray intersect each other. An intersection test between the bounding volume and the ray may use a small amount of calculation compared to an intersection test between the primitive and the ray and thus, an amount of calculation used for rendering of the image processing apparatus may significantly decrease.

### CROSS-REFERENCE TO RELATED APPLICATIONS

This application claims the priority benefit of Korean Patent Application No. 10-2012-0013518, filed on Feb. 10, 2012, in the Korean Intellectual Property Office, the disclosure of which is incorporated herein by reference.

### BACKGROUND

1. Field

Embodiments relate to an image processing apparatus and method that may perform an intersection test between a ray and a primitive in image rendering using a ray tracing scheme.

2. Description of the Related Art

Three-dimensional (3D) rendering may be an image processing scheme of synthesizing 3D object data into an image observed at a given camera viewpoint.

A rendering method may include a rasterization method of generating an image while projecting a 3D object onto a screen, a ray tracing method of generating an image by tracing a path of light incident along a ray towards each pixel of an image at a camera viewpoint, and the like.

Here, the ray tracing method may reflect physical properties of light such as reflection, refraction, transmission, and the like, for example, and thus may generate a high quality image. However, due to a relatively great amount of calculation, the ray tracing method may have difficulty in quickly rendering an image.

In the ray tracing performance, a large amount of calculation may be used for generation and traversal (TRV) of an acceleration structure (AS) in which scene objects to be rendered are spatially divided, and an intersection test (IST) between a ray and a primitive.

### SUMMARY

According to an aspect of one or more embodiments, there is provided an image processing apparatus for performing rendering by employing a ray tracing scheme to a rendering image including a plurality of primitives, the image processing apparatus including a bounding volume intersection determining unit (bounding volume intersection determiner) to determine whether a ray and a bounding volume including a target primitive intersect each other, wherein the target primitive is selected from among the plurality of primitives, and a primitive intersection determining unit (primitive intersection determiner) to determine whether the target primitive and the ray intersect each other, when the bounding volume and the ray intersect each other.

The bounding volume may be in a rectangular shape.

The rendering image may be a rectangle, and sides of the bounding volume may be in parallel with the respective corresponding sides of the rendering image.

The image processing apparatus may further include a bounding volume determining unit to determine the bounding volume with respect to the target primitive.

The image processing apparatus may further include a space divider to divide the rendering image into a plurality of nodes including at least one primitive among the plurality of primitives.

The space divider may generate a tree-shaped node structure by subdividing each of the plurality of nodes.

The space divider may divide the rendering image based on the number of primitives included in each node.

The bounding volume may be a rectangular shape and the plurality of primitives may be a triangular shape.

A shadowing unit (shadower) may determine that the target primitive corresponds to a pixel based on ray movement and may determine a color of the pixel, when the primitive intersection determining unit determines that the ray and the target primitive intersect each other.

A size of the tree-shaped node structure may be controlled based on a maximum number of primitives within each node and a maximum depth value of the tree.

According to one or more embodiments, there is provided an image processing method for performing rendering by employing a ray tracing scheme to a rendering image including a plurality of primitives, the method including determining whether a ray and a bounding volume including a target primitive and intersect each other, wherein the target primitive is selected from among the plurality of primitives, and determining whether the target primitive and the ray intersect each other, when the bounding volume and the ray intersect each other.

The bounding volume may be in a rectangular shape.

The rendering image may be a rectangle, and sides of the bounding volume may be in parallel with the respective corresponding sides of the rendering image.

An image processing method may further include determining the bounding volume with respect to the target primitive.

An image processing method may further include dividing the rendering image into a plurality of nodes including at least one primitive among the plurality of primitives.

An image processing method may further include generating a tree-shaped node structure by subdividing each of the plurality of nodes.

The dividing may include dividing the rendering image based on the number of primitives included in each node.

The bounding volume may be a rectangular shape and the plurality of primitives may be a triangular shape.

An image processing method may further include determining that the target primitive corresponds to a pixel based on ray movement and determining a color of the pixel, when the ray and the target primitive intersect each other.

A size of the tree-shaped node structure may be controlled based on a maximum number of primitives within each node and a maximum depth value of the tree.

According to an aspect of one or more embodiments, there is provided at least one non-transitory computer readable medium storing computer readable instructions to implement methods of embodiments.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an example of determining whether a bounding volume and a ray intersect each other according to an embodiment;

FIG. 2 illustrates a structure of an image processing apparatus according to an embodiment;

FIG. 3 illustrates a node structure according to an embodiment;

FIG. 4 illustrates a structure of an image processing apparatus according to an embodiment;

FIG. 5 illustrates an image processing method according to an embodiment; and

FIGS. 6A and 6B illustrate a memory loading method according to an embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

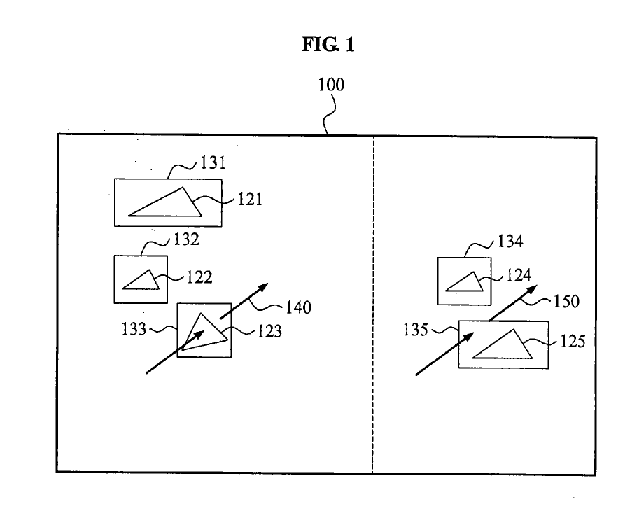

FIG. 1 illustrates an example of determining whether a bounding volume and a ray intersect each other according to an embodiment.

A rendering image 100 may include a plurality of primitives 121, 122, 123, 124, and 125. Each of the primitives 121, 122, 123, 124, and 125 may be a type of a polygon having three-dimensional (3D) coordinates. An image processing apparatus may determine coordinates of each of the primitives 121, 122, 123, 124, and 125 within the rendering image 100.

To determine coordinates of each of the primitives 121, 122, 123, 124, and 125 within the rendering image 100, the image processing apparatus may determine whether a ray and each of the primitives 121, 122, 123, 124, and 125 intersect each other. Here, the ray may move straight from a camera observing the rendering image 100 to a pixel of a screen on which the rendering image 100 is displayed. When the ray and each of the primitives 121, 122, 123, 124, and 125 intersect each other, each of the primitives 121, 122, 123, 124, and 125 may be displayed on a corresponding pixel of the screen.

In this example, the number of rays corresponding to the number of pixels of the screen on which the rendering image 100 is displayed may be present. Accordingly, when the number of rays corresponding to the number of pixels and the respective primitives 121, 122, 123, 124, and 125 collide with each other, which pixel of the screen corresponds to which primitive may be determined.

However, a relatively large amount of calculation may be used to determine collision between the rays and the primitives 121, 122, 123, 124, and 125. Accordingly, a spatial division scheme of dividing the rendering image 100 into a plurality of nodes and determining whether primitives included in a predetermined node and a ray collide with each other may be used. Referring to FIG. 1, the rendering image 100 is divided into a first node including the primitives 121, 122, and 123, and a second node including the primitives 124 and 125.

According to the example of FIG. 1, in the case of a first ray 140, an intersection test may be performed with respect to the primitives 121, 122, and 123 that are included in the first node via which the first ray 140 passes. In the case of a second ray 150, an intersection test may be performed with respect to the primitives 124 and 125 that are included in the second node via which the second ray 150 passes. Accordingly, an amount of calculation may be significantly reduced.

However, when the primitives 121, 122, 123, 124, and 125 are in a triangular shape, a trigonometric function needs to be used for an intersection test between each of the primitives 121, 122, 123, 124, and 125 and a corresponding ray.

According to an embodiment, the image processing apparatus may perform an intersection test with respect to bounding volumes 131, 132, 133, 134, and 135 including the primitives 121, 122, 123, 124, and 125, respectively, instead of performing an intersection test with respect to the primitives 121, 122, 123, 124, and 125. In this example, to decrease an amount of calculation used for the intersection test, the bounding volumes 131, 132, 133, 134, and 135 may be in a rectangular shape as shown in FIG. 1.

The image processing apparatus may perform an intersection test with respect to the bounding volumes 131, 132, 133, 134, and 135 including the primitives 121, 122, 123, and 124, and 125, respectively. Only when a ray and a bounding volume intersect each other, the image processing apparatus may perform an intersection test again between the ray and a primitive included in the bounding volume. Accordingly, it is possible to significantly decrease an amount of calculation used for the intersection test.

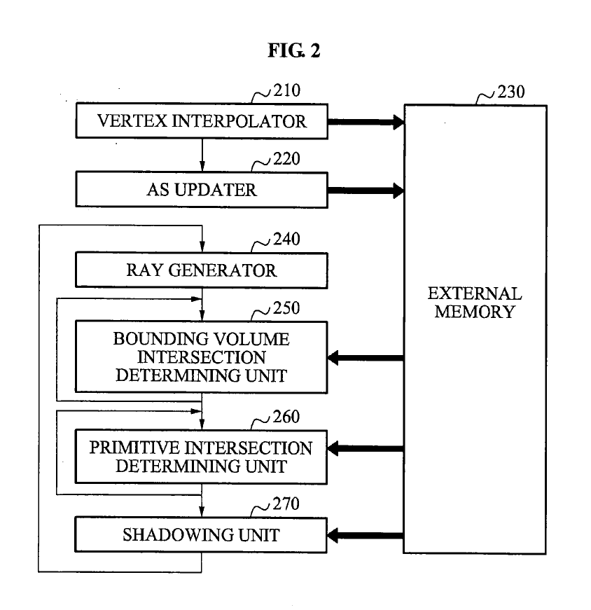

FIG. 2 illustrates a structure of an image processing apparatus according to an embodiment.

Referring to FIG. 2, the image processing apparatus may include a vertex interpolator 210, an acceleration structure (AS) updater 220, an external memory 230, a ray generator 240, a bounding volume intersection determining unit 250, a primitive intersection determining unit 260, and a shadowing unit 270.

The vertex interpolator 210 may perform interpolation with respect to a vertex of a primitive and may store an interpolation result in the external memory 230.

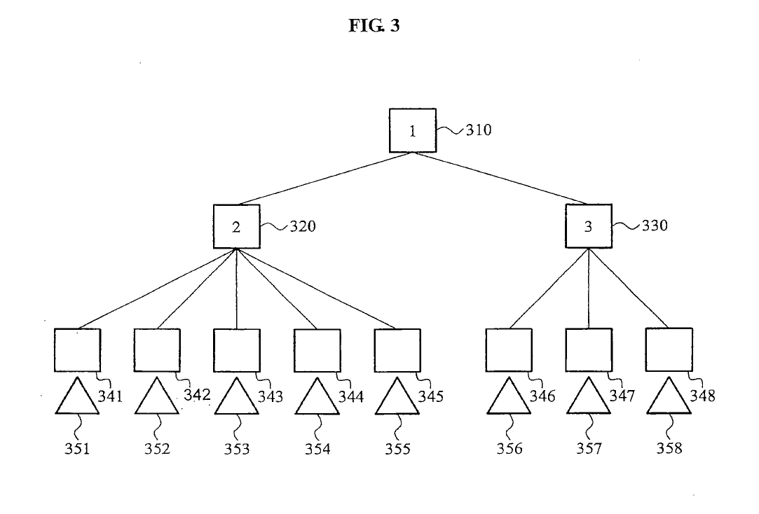

The AS updater 220 may determine a bounding volume including a corresponding primitive for each primitive, and may store the determined bounding volume in the external memory 230. The AS updater 220 may divide a rendering image into at least one node, and may determine a node including each primitive. Hereinafter, a method of dividing the rendering image into at least one node will be further described with reference to FIG. 3.

The ray generator 240 may generate a ray corresponding to each pixel of a screen on which the rendering image is displayed. Each ray may move straight through each pixel from a camera corresponding to a viewpoint of the rendering image.

The bounding volume intersection determining unit 250 may determine whether the generated ray intersects a bounding volume including a primitive. When the generated ray does not intersect the bounding volume including the primitive, the generated ray may not intersect the primitive that is included in the bounding volume. Accordingly, the bounding volume intersection determining unit 250 may not determine any more whether the primitive and the ray intersect each other, and may determine whether the ray intersects another bounding volume.

On the contrary, when the generated ray intersects the bounding volume including the primitive, the primitive intersection determining unit 260 may determine whether the ray intersects the primitive that is included in the bounding volume. The primitive may be in a triangular shape and the bounding volume may be in a rectangular shape. In this example, the primitive may partially occupy an area of the bounding volume. Accordingly, even though the ray and the bounding volume intersect each other, the ray and the primitive may not intersect each other.

When the ray and the primitive are determined to intersect each other, the shadowing unit 270 may determine that the primitive corresponds to a pixel via which the ray moves, and may determine a color of the pixel.

FIG. 3 illustrates a node structure according to an embodiment.

Referring to FIG. 3, a root node 310 may include all the primitives 351, 352, 353, 354, 355, 356, 357, and 358 that are included in a rendering image. The root node 310 may be divided into a plurality of sub nodes, for example, a first sub node 320 and a second sub node 330. The plurality of sub nodes may dividedly include the primitives 351, 352, 353, 354, 355, 356, 357, and 358 that are included in the root node 310. In FIG. 3, the first sub node 320 may include the primitives 351, 352, 353, 354, and 355, and the second sub node 330 may include the primitives 356, 357, and 358.

According to an embodiment, a sub node may be subdivided into other sub nodes. The image processing apparatus may generate a tree-shaped node structure by dividing each of the sub nodes. Here, a sub node that does not include another sub node in a lower layer and includes a primitive may be referred to as a leaf node.

When the image processing apparatus performs an intersection test with respect to a predetermined primitive, a sub node including the predetermined primitive may be traversed using the tree-shaped node structure. When a tree including sub nodes has a deep depth, the image processing apparatus may need to perform a large amount of operation to perform a traversal for the sub node including the predetermined primitive.

According to an embodiment, the image processing apparatus may divide or subdivide a root node or a sub node based on the number of primitives that are included in the root node or the sub node. To decrease the depth from the root node to a leaf node, the image processing apparatus may divide a node into sub nodes according to Equation 1.

$$T = 2 \cdot {T}_{AABB} + \frac{A ( {S}_{1} )}{A ( S )} \cdot N ( {S}_{1} ) \cdot {T}_{tri} + \frac{A ( {S}_{2} )}{A ( S )} \cdot N ( {S}_{2} ) \cdot {T}_{tri} \qquad [ Equation 1 ]$$

In Equation 1, T_{AABB} denotes cost for traversal of the tree and Tₜᵣᵢ denotes cost for an intersection test with respect to a primitive. Also, A(S₁) and A(S₂) denote surface areas that surround sets S1 and S2 of primitives that are included in a region 1 and a region 2, respectively, when each node is divided into the region 1 and the region 2. N(S₁) and N(S₂) denote the number of primitives that are included in S1 and S2, respectively.

According to Equation 1, a leaf node generation condition may vary based on a ratio between T_{AABB} and Tₜᵣᵢ. Here, a small tree having a shallow depth may be generated according to a relative increase in a value of T_{AABB}, and a large tree having a deep depth may be generated according to a relative increase in a value of Tₜᵣᵢ.

The image processing apparatus may also control a tree size based on the maximum number of primitives within a node and a maximum depth value of the tree. When the maximum number of primitives within the node is set to be great, the number of primitives within a leaf node may increase and thus, a shallow tree, that is, the small tree with the shallow depth may be generated. On the contrary, when the maximum number of primitives is set to be small, a deep tree, that is, the large tree with the deep depth may be generated. That is, the deep tree may be generated according to an increase in the maximum depth value of the tree. According to a decrease in the maximum depth value of the tree, the shallow tree may be generated.

When the tree depth becomes deep, it may take a relatively large amount of time to generate the tree and a size of the tree may also increase. Also, in the case of rendering, the number of traversals may increase whereas the number of intersection tests between a ray and a primitive may decrease. On the contrary, when the tree depth becomes shallow, it may take a relatively small amount of time to generate the tree and the size of the tree may also decrease. Also, in the case of rendering, the number of traversals may decrease whereas the number of intersection tests between a ray and a primitive may increase.

Referring to FIG. 3, the primitives 351, 352, 353, 354, 355, 356, 357, and 358 may be included in bounding volumes 341, 342, 343, 344, 345, 346, 347, and 348, respectively. The image processing apparatus may decrease an amount of calculation required for an intersection test by initially performing an intersection test with respect to the bounding volumes 341, 342, 343, 344, 345, 346, 347, and 348. Accordingly, even though each sub node includes a large number of primitives, an amount of calculation for traversal of a predetermined sub node may be less than a case where a bounding volume is not used. Accordingly, the depth of the tree including sub nodes may decrease and the image processing apparatus may more quickly determine a leaf node that including each of the primitives 351, 352, 353, 354, 355, 356, 357, and 358.

Accordingly, when the image processing apparatus uses a bounding volume, a relatively simple structured tree with a relatively shallow depth may be used and a data amount of the tree may decrease. In addition, since a tree traversal may be simply performed, it is possible to decrease the entire rendering time.

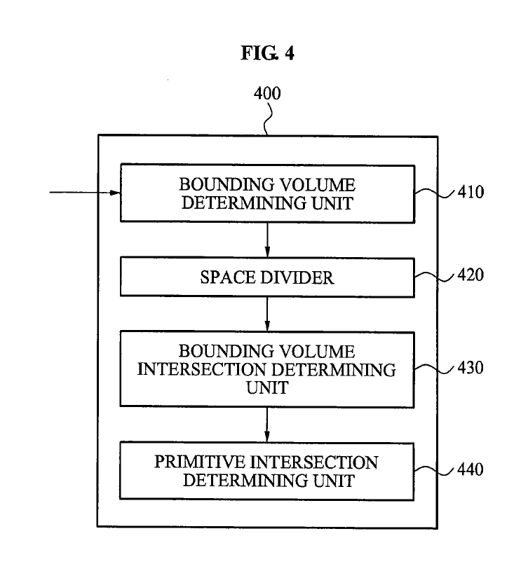

FIG. 4 illustrates a structure of an image processing apparatus 400 according to another embodiment. Referring to FIG. 4, the image processing apparatus 400 may include a bounding volume determining unit 410, a space divider 420, a bounding volume intersection determining unit 430, and a primitive intersection determining unit 440.

The image processing apparatus 400 may perform rendering by applying a ray tracing scheme to a rendering image including a plurality of primitives.

The bounding volume determining unit 410 may determine a bounding volume including a corresponding primitive with respect to each of the plurality of primitives that are included in the rendering image. A primitive may be in a triangular shape, and the bounding volume may be in a rectangular shape including the primitive. The rendering image may be in a rectangular shape, and the bounding volume may be a rectangle of which four sides are in parallel with four sides of the rendering image, respectively.

The space divider 420 may generate a root node including all the primitives that are included in the rendering image. The space divider 420 may divide the root node into sub nodes. Each of the sub nodes may include at least one of the primitives that are included in the root node. Each of the sub nodes may be subdivided into sub nodes. That is, a sub node and a subdivided sub node may have a relationship of an upper node and a lower node.

The space divider 420 may generate a tree-shaped node structure by dividing or subdividing the root node including all the primitives that are included in the rendering image. A bottom-positioned sub node that is not subdivided into sub nodes any more may be referred to as a leaf node.

The space divider 420 may divide or subdivide the root node or the sub node based on the number of primitives that are included in the root node or the sub node.

With respect to a target primitive, the bounding volume intersection determining unit 430 may determine whether a ray and a bounding volume including the target primitive intersect each other.

When the ray and the bounding volume including the target primitive intersect each other, the primitive intersection determining unit 440 may determine whether the ray and the target primitive intersect each other. On the contrary, when the ray and the bounding volume including the target primitive do not intersect each other, the primitive intersection determining unit 440 may not perform an intersection test between the target primitive and the ray. The intersection test for the bounding volume may be significantly simple and use a small amount of calculation compared to the intersection test for the target primitive. Accordingly, when using the bounding volume, the intersection test for the target primitive may be simply performed with a relatively small amount of calculation.

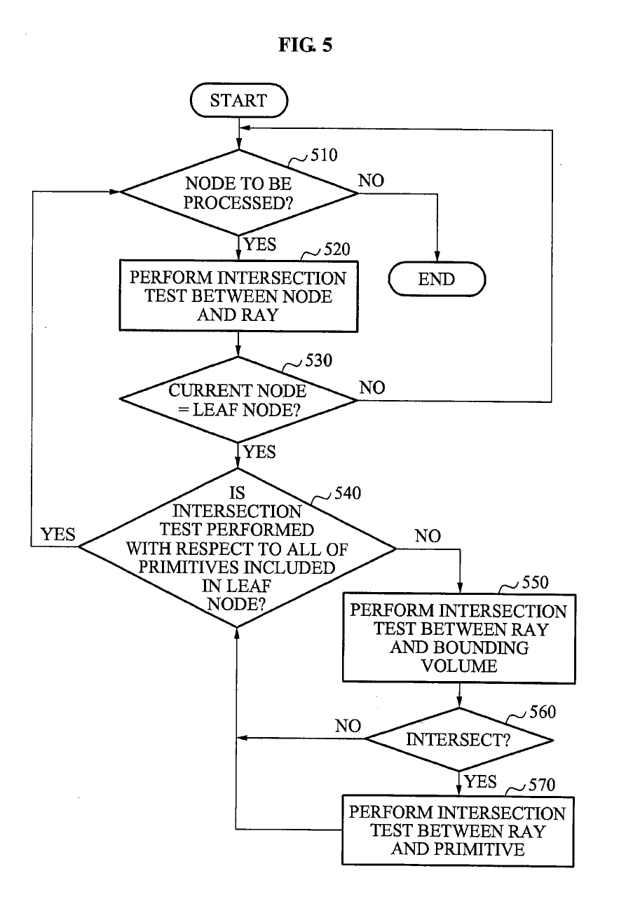

FIG. 5 illustrates an image processing method according to an embodiment.

An image processing apparatus may perform rendering by applying a ray tracing scheme with respect to a rendering image including a plurality of primitives.

The image processing apparatus may determine a bounding volume including a corresponding primitive with respect to each of the plurality of primitives that are included in the rendering image. A primitive may be in a triangular shape, and the bounding volume may be in a rectangular shape including the primitive. The rendering image may be in a rectangular shape, and the bounding volume may be a rectangle of which four sides are in parallel with four sides of the rendering image, respectively.

The image processing apparatus may generate a root node including all the primitives that are included in the rendering image. The image processing apparatus may divide the root node into sub nodes. Each of the sub nodes may include at least one of the primitives that are included in the root node. Each of the sub nodes may be subdivided into sub nodes. That is, a sub node and a subdivided sub node may have a relationship of an upper node and a lower node.

The image processing apparatus may generate a tree-shaped node structure by dividing or subdividing the root node including all the primitives that are included in the rendering image. A bottom-positioned sub node that is not subdivided into sub nodes any more may be referred to as a leaf node.

The image processing apparatus may perform rendering with respect to primitives included in each node by employing each of the nodes as a unit.

In operation 510, the image processing apparatus may determine whether there is a node to be processed.

When there is a node to be processed, the image processing apparatus may perform an intersection test between a corresponding node and a ray in operation 520. When the node and the ray do not interest, there is no need to perform an intersection test with respect to the node and thus, the image processing apparatus may process a subsequent node in operation 510.

In operation 530, the image processing apparatus may determine whether a current node is a leaf node. When the current node is not the leaf node, the current node may be divided into sub nodes. In this example, the image processing apparatus may perform processing of a sub node, instead of performing processing of the current node, in operation 510.

On the contrary, when the current node is the leaf node, the image processing apparatus may determine whether an intersection test is performed with respect to all the primitives included in the leaf node in operation 540. When the intersection test is performed with respect to all the primitives included in the leaf node in operation 540, processing of the corresponding leaf node may be completed and thus, the image processing apparatus may perform processing of a subsequent node in operation 510.

On the contrary, when there is a primitive of which an intersection test is to be performed, the image processing apparatus may perform an intersection test between the ray and a bounding volume including the primitive in operation 550.

The primitive may be in a triangular shape, and the bounding volume may be in a rectangular shape including the primitive. The rendering image may be in a rectangular shape, and the bounding volume may be a rectangle of which four sides are in parallel with four sides of the rendering image, respectively. Accordingly, an intersection test between the primitive and the ray may be complex and use a relatively large amount of calculation, whereas an intersection test between the bounding volume and the ray may be simple and use a relatively small amount of calculation.

When the bounding volume and the ray are determined to intersect each other in operation 560, the image processing apparatus may perform an intersection test between the ray and the primitive in operation 570.

According to an embodiment, the image processing apparatus may perform an intersection test between a bounding volume and a ray using a simple operation and may perform a complex operation of an intersection test between the ray and the primitive only when the bounding volume and the ray intersect each other. Accordingly, a total amount of calculation used to determine a pixel corresponding to each primitive included in the rendering image may decrease.

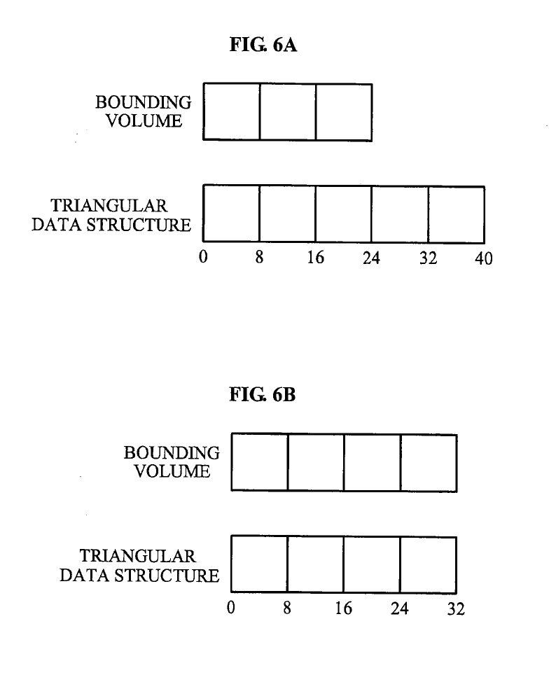

FIGS. 6A and 6B illustrate a memory loading method according to an embodiment.

According to an embodiment, a data structure of a primitive may become efficient and thus, a method of loading a primitive to a memory may be simplified.

Since a primitive is in a triangular shape, data of 40 bytes for each primitive may be used to determine an intersection test between a ray and a primitive. In this case, when a padding for cache alignment is included, data of 48 bytes may be used. FIG. 6A illustrates a data structure using data of 40 bytes for each primitive.

When an embodiment for the data structure of FIG. 6A is performed using hardware in which a cache block includes 32 bytes, one-time memory loading may be required to load bounding volume 24 bytes, and twice memory loading may be required to load primitive 40 bytes. Accordingly, all of three-times of memory loading may be required.

According to an embodiment, memory loading may be effectively performed using a cache-aligned data structure based on a unit of 32 bytes. Referring to FIG. 6B, each of a bounding volume and a primitive may use data of 32 bytes. Accordingly, when using hardware in which a cache block includes 32 bytes, data for determining a collision may be loaded to the cache block using only twice memory loading.

According to embodiments, it is possible to determine a pixel of a screen corresponding to a primitive included in a rendering image using a small amount of calculation.

Also, according to embodiments, it is possible to simply determine whether a primitive and a ray collide with each other.

Image processing methods according to the above-described embodiments may be recorded (stored) in one or more non-transitory computer-readable media including program instructions (computer readable instructions) to be implemented by a computer to cause one or more processors to execute or perform the program (computer readable instructions). The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. In addition, one or more non-transitory computer-readable storage media may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA)

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image processing apparatus for performing rendering by employing a ray tracing scheme to a rendering image comprising a plurality of primitives, the image processing apparatus comprising:
a bounding volume intersection determiner, using at least one processor, to determine whether a ray and a bounding volume comprising a target primitive intersect each other, wherein the target primitive is selected from among the plurality of primitives; and
a primitive intersection determiner to determine whether the target primitive and the ray intersect each other, when the bounding volume and the ray intersect each other.

2. The image processing apparatus of claim 1, wherein the bounding volume is in a rectangular shape.

3. The image processing apparatus of claim 1, wherein:
the rendering image is a rectangle, and
sides of the bounding volume are in parallel with the respective corresponding sides of the rendering image.

4. The image processing apparatus of claim 1, further comprising:
a bounding volume determiner to determine the bounding volume with respect to the target primitive.

5. The image processing apparatus of claim 1, further comprising:
a space divider to divide the rendering image into a plurality of nodes comprising at least one primitive among the plurality of primitives.

6. The image processing apparatus of claim 5, wherein the space divider generates a tree-shaped node structure by subdividing each of the plurality of nodes.

7. The image processing apparatus of claim 5, wherein the space divider divides the rendering image based on the number of primitives included in each node.

8. An image processing method for performing rendering by employing a ray tracing scheme to a rendering image comprising a plurality of primitives, the method comprising:
determining, using at least one processor, whether a ray and a bounding volume comprising a target primitive and intersect each other, wherein the target primitive is selected from among the plurality of primitives; and
determining whether the target primitive and the ray intersect each other, when the bounding volume and the ray intersect each other.

9. The method of claim 8, wherein the bounding volume is in a rectangular shape.

10. The method of claim 8, wherein:
the rendering image is a rectangle, and
sides of the bounding volume are in parallel with the respective corresponding sides of the rendering image.

11. The method of claim 8, further comprising:
determining the bounding volume with respect to the target primitive.

12. The method of claim 8, further comprising:
dividing the rendering image into a plurality of nodes comprising at least one primitive among the plurality of primitives.

13. The method of claim 12, further comprising:
generating a tree-shaped node structure by subdividing each of the plurality of nodes.

14. The method of claim 12, wherein the dividing comprises dividing the rendering image based on the number of primitives included in each node.

15. At least one non-transitory computer-readable medium storing computer readable instructions that control at least one processor to implement the method of claim 8.

16. The image apparatus of claim 1, further comprising a shadower, which determines that the target primitive corresponds to a pixel based on ray movement and determines a color of the pixel, when the primitive intersection determiner determines that the ray and the target primitive intersect each other.

17. The image apparatus of claim 6, wherein a size of the tree-shaped node structure is controlled based on a maximum number of primitives within each node and a maximum depth value of the tree.

18. The method of claim 8, further comprising determining that the target primitive corresponds to a pixel based on ray movement and determining a color of the pixel, when the ray and the target primitive intersect each other.

19. The method of claim 13, wherein a size of the tree-shaped node structure is controlled based on a maximum number of primitives within each node and a maximum depth value of the tree.
